(19) United States
(12) Patent Application Publication
(10) Pub. No.: US 2012/0031364 A1
(43) Pub. Date: Feb. 9, 2012

(54) Intake manifold and collar with interlocking molded seals

(76) Inventor: David J. Schweiger, Pewaukee, WI (US)

(21) Appl. No.: 12/806,273

(22) Filed: Aug. 9, 2010

(51) Int. Cl. F02M 35/10

(52) U.S. Cl. 123/184.21

(57) ABSTRACT

A manifold assembly is provided having an engine manifold, a mounting collar, and a resilient annulet. The mounting collar is disposed on the engine manifold and the resilient annulet is coupled to the mounting collar. The engine manifold has an inlet, an outlet, a resilient sleeve, and a primary protuberance. The resilient sleeve is coupled to the outer surface of the engine manifold and the primary protuberance is formed on the outer surface of the engine manifold. The mounting collar has a secondary protuberance and a manifold aperture formed therein. The resilient annulet is coupled to the manifold aperture. The resilient annulet is sealingly engaged with the resilient sleeve and the primary protuberance abuts the secondary protuberance. The manifold assembly for an engine minimizes a required number of components, minimizes a time of assembly of the manifold assembly, and militates against a rotation of the engine manifold.

### FIELD OF THE INVENTION

The present invention relates to an engine manifold and a mounting collar for the engine manifold having a resilient sleeve and a resilient annulet disposed between the mounting collar and the engine manifold.

### BACKGROUND OF THE INVENTION

Manifold assemblies typically include at least one seal to militate against an escape of intake gases and exhaust gases. An engine manifold typically compresses a seal disposed between the engine manifold and a cylinder head. The engine manifold is urged towards the cylinder head by a mounting collar disposed on the engine manifold. An adjustable fastener coupling the mounting collar to the cylinder head permits an urging force to be varied. Upon compression of the seal, the engine manifold is rigidly coupled to the cylinder head, and little relative movement between the engine manifold and the cylinder head is afforded. Such manifold assemblies require a plurality of components, undesirably increasing the complexity of the manifold assembly.

Coupling the manifold assembly including the plurality of components may become an arduous or a time consuming task. A positioning of the seal with respect to the cylinder head and the engine manifold, an alignment of the adjustable fasteners and the mounting collar, application of nuts, washers, and thread locking fluid, and the urging force of each fastener must be given particular attention during assembly to ensure proper sealing between the cylinder head and the engine manifold. The engine manifold having a plurality of manifold inlets or a plurality of manifold outlets further complicates coupling the engine manifold to the cylinder head, as simultaneous attention must be given to each of the manifold inlets or each of the manifold outlets. The plurality of components of the manifold assembly undesirably increases an assembly time and an amount of required component manipulation during assembly of the manifold assembly.

It is common for portions of an engine assembling process to occur in a plurality of locations. Partially assembled engines and non-operational assembled engines may be transported within a facility or to another facility for further assembly or installation. During transportation of the partially assembled engines and non-operational assembled engines, engine components may move in an undesirable manner. Particularly, the engine manifold may rotate with respect to the cylinder head during transportation of the partially assembled engines and non-operational assembled engines. A rotation of the engine manifold during transportation may result in damage to the seal disposed between the cylinder head and the engine manifold. Further, correction of a positioning of the engine manifold may result in an undesirable increase in a duration of the engine assembling process.

It would be advantageous to utilize a manifold assembly for an engine that minimizes a required number of components, minimizes a time of assembly of the manifold assembly, and militates against a rotation of an engine manifold.

### SUMMARY OF THE INVENTION

Presently provided by the invention, a manifold assembly for an engine that minimizes a required number of components, minimizes a time of assembly of the manifold assembly, and militates against a rotation of an engine manifold, has surprisingly been discovered.

In one embodiment, the present invention is directed toward a manifold assembly for an engine having an engine manifold, a mounting collar, and a resilient annulet. The mounting collar is disposed adjacent an outlet of the engine manifold and the resilient annulet is coupled to the mounting collar.

The engine manifold has an inlet, an outlet, a resilient sleeve, and a primary protuberance. The resilient sleeve is coupled to the outer surface of the engine manifold and the primary protuberance is formed adjacent the outlet on the outer surface of the engine manifold.

The mounting collar is disposed adjacent the outlet of the engine manifold. The mounting collar has a secondary protuberance and an inner peripheral wall. The inner peripheral wall defines a manifold aperture formed through the mounting collar.

The resilient annulet is coupled to the inner peripheral wall. The resilient annulet is sealingly engaged with the resilient sleeve. The primary protuberance abuts the secondary protuberance to prevent a rotation of the engine manifold with respect to the mounting collar.

### BRIEF DESCRIPTION OF THE DRAWINGS

The above, as well as other advantages of the present invention, will become readily apparent to those skilled in the art from the following detailed description when considered in the light of the accompanying drawings in which:

FIG. 1 is an exploded perspective view of a manifold assembly for an engine according to an embodiment of the present invention;

FIG. 2 is a fragementary perspective view of the manifold assembly illustrated in FIG. 1, a mounting collar of the assembly coupled to a cylinder head; and

FIG. 3 is a cross-sectional, top elevational view of the manifold assembly shown in FIG. 1, taken along section line 3-3 in FIG. 2.

### DETAILED DESCRIPTION OF THE PREFERRED EMBODIMENTS

It is to be understood that the invention may assume various alternative orientations and step sequences, except where expressly specified to the contrary. It is also to be understood that the specific devices and processes illustrated in the attached drawings, and described in the following specification are simply exemplary embodiments of the inventive concepts defined in the appended claims. Hence, specific dimensions, directions or other physical characteristics relating to the embodiments disclosed are not to be considered as limiting, unless the claims expressly state otherwise.

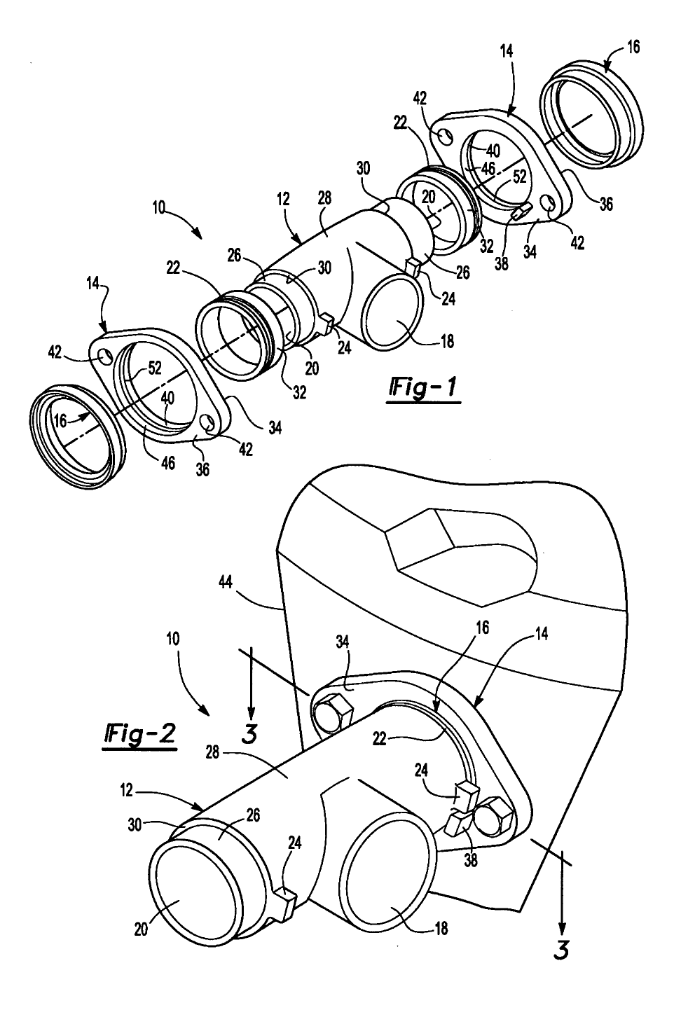

FIGS. 1-3 illustrate a manifold assembly 10 for an engine according to an embodiment of the present invention. The manifold assembly comprises an engine manifold 12, a mounting collar 14, and a resilient annulet 16. As shown, the manifold assembly 10 is an intake manifold assembly, but the manifold assembly 10 may be an exhaust manifold assembly.

The engine manifold 12 has an inlet 18, at least one outlet 20, a resilient sleeve 22, and a primary protuberance 24. The engine manifold 12 is typically formed by casting a metal, such as aluminum, but other processes such as machining or forging may be used to form the engine manifold 12. As illustrated, the engine manifold 12 is a hollow body having one inlet 18 and two outlets 20. However, any number of inlets 18 and outlets 20 may be formed in the engine manifold 12.

A cross-sectional shape of the engine manifold 12 adjacent the inlet 18 and the outlets 20 is substantially ring shaped. Alternately, other cross-sectional shapes such as rectangles, ellipses, or other closed shapes may be used.

A portion of the engine manifold 12 adjacent the at least one outlet 20 has a diameter less than a remaining portion of the engine manifold 12, forming a stepped portion 26. The stepped portion 26 is formed in an outer surface 28 of the engine manifold 12 adjacent the outlet 20 of the engine manifold 12. A depth of a stepped wall 30 is substantially equal to a thickness of the resilient sleeve 22. Alternately, the engine manifold 12 may be tapered to form the portion of the engine manifold 12 having a diameter less than a remaining portion of the engine manifold 12 and a stepped portion 26 may be formed in the outer surface 28 adjacent the inlet 18 of the engine manifold 12. The engine manifold 12 may include an aperture (not shown) formed therein for coupling a sensor or other device thereto. Further, the engine manifold 12 may include a bracket (not shown) formed therewith for coupling a device or a support member thereto.

The inlet 18 is a finish of the engine manifold 12 having a substantially circular peripheral edge. A portion of the engine manifold 12 adjacent the inlet 18 may be adapted for receiving a resilient coupler (not shown) by having a stepped portion formed therein or having the outer surface 28 adjacent thereto refined for receiving the resilient coupler. The resilient coupler may couple a fuel mixing device, an intake conduit, or an exhaust conduit to the inlet 18. Alternately, the inlet 18 may include a mounting flange (not shown) formed therewith.

The outlet 20 is a finish of the engine manifold 12 having a substantially circular peripheral edge. As mentioned hereinabove, the stepped portion 26 is formed adjacent the outlet 20 of the engine manifold 12, onto which the resilient sleeve 16 is disposed. Alternately, the outer surface 26 of the engine manifold 12 adjacent the outlet 20 may be refined for receiving the resilient sleeve 22.

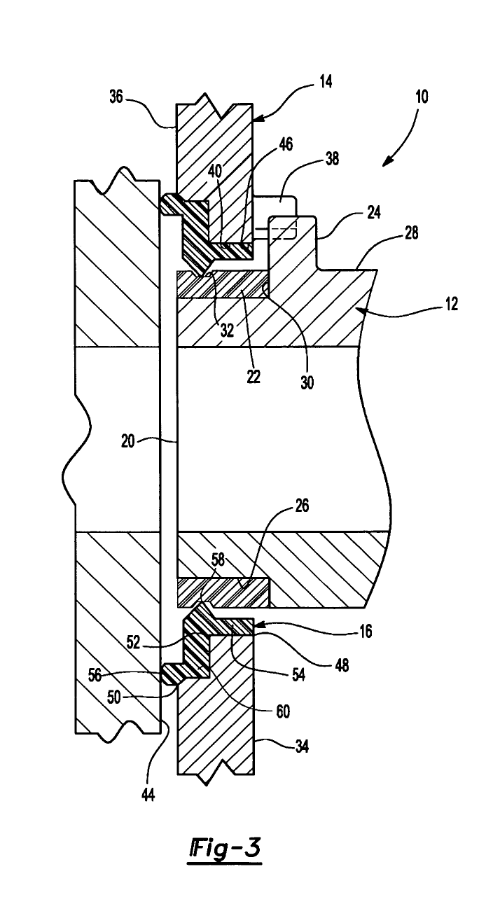

As most clearly illustrated in FIGS. 1 and 3, the resilient sleeve 22 is an annulet having a substantially elongate rectangular profile. The substantially elongate rectangular profile of the resilient sleeve 22 substantially corresponds to a shape of the stepped portion 26. The resilient sleeve 22 is coupled to the stepped portion 26 of the engine manifold 12 adjacent the at least one outlet 20 of the engine manifold 12. When the resilient sleeve 22 is disposed on the stepped portion 26, an outer surface of resilient sleeve 22 substantially corresponds to the outer surface 28 of the engine manifold 12. The resilient sleeve 22 is formed from an elastomeric material, however any other suitable material typically used to form seals or the like may be used.

The resilient sleeve 22 is molded to the stepped portion 26. The engine manifold 12 including the resilient sleeve 22 molded to the stepped portion 26 is formed by placing the engine manifold 12 within a set of molding dies (not shown) corresponding to a shape of the engine manifold 12 including the resilient sleeve 22. A moldable material is injected into the set of molding dies, the moldable material adhering to the stepped portion 26 to form the engine manifold 12 including the resilient sleeve 22 molded to the stepped portion 26. Alternately, an adhesive disposed between the resilient sleeve 22 and the stepped portion 26 may couple the resilient sleeve 22 thereto. Further, a frictional force between the resilient sleeve 22 and the stepped portion 26 may couple the resilient sleeve 22 thereto.

A sealing groove 32 is formed in the resilient sleeve 22. The sealing groove 32 is a circumferential trough shaped groove formed in the outer surface of the resilient sleeve 22, but any other shaped groove such as a “V” shaped groove, a rectangular groove, or a semi-circular groove may be used. The sealing groove 32 is formed intermediately between a first distal end and a second distal end of the resilient sleeve 22. However, the sealing groove 32 may be formed adjacent the first distal end or the second distal end of the resilient sleeve 22. Further, the sealing groove 32 may be a stepped portion of the resilient sleeve 22. At least a portion of the resilient annulet 16 is shaped to correspond to the sealing groove 32. Alternately, the resilient sleeve 22 may include a ridge formed therewith.

The primary protuberance 24 is a body extending from the outer surface 28 of the engine manifold 12. As shown, the primary protuberance 24 is a rectangular prism having a plurality of rounded edges and a rounded transitionary surface formed between the primary protuberance 24 and the outer surface 28 of the engine manifold 12. However, other shapes such as a cylindrical prism, a bulbous protuberance, or any other shape may be used. The primary protuberance 24 is formed adjacent the outlet 20 on an outer surface 28 of the engine manifold 12. As most clearly shown in FIG. 3, the stepped wall 30 forms a portion of the primary protuberance 24. Alternately, the primary protuberance 24 may be formed elsewhere on the outer surface 28 adjacent the outlet 20.

The primary protuberance 24 is unitarily formed with the engine manifold 12, but may be formed separate the engine manifold 12 and coupled thereto using a fastener, a weld, or the like. As illustrated in FIG. 1, the engine manifold 12 includes two primary protuberances 24 formed therewith, each of the primary protuberances 24 formed adjacent the outlets 20 of the engine manifold 12.

The mounting collar 14 is a unitary body having a first inner surface 34, a second outer surface 36, a secondary protuberance 38, a manifold aperture 40 formed therethrough, and a fastening point 42 formed therein. The mounting collar 14 is typically formed by casting a metal such as a steel, but other processes such as stamping, machining, or forging may be used to form the mounting collar 14. A shape of a central portion of the mounting collar 14 is substantially circular, the central portion having two diametrically opposed rounded tabs extending therefrom, each of the rounded tabs meeting the central portion tangentially. Alternately, the mounting collar 14 may be any other shape and may have any number of tabs extending therefrom. As illustrated in FIG. 1, the manifold assembly 10 includes two mounting collars 14, each of the mounting collars 14 including one secondary protuberance 38 and two fastening points 42 formed therein. However, the mounting collar 14 may include any number of secondary protuberances 38 and any number of fastening points 42 formed therein. As shown in FIGS. 2 and 3, the mounting collar 14 is disposed on the engine manifold 12, the resilient annulet 16 and resilient sleeve 22 disposed therebetween. The mounting collar 14 is coupled to a cylinder head 44, the second outer surface 36 disposed adjacent the cylinder head 44. The collar 14 may also be coupled to a cylinder block.

The secondary protuberance 38 is a body extending from the first inner surface 34 of the mounting collar 14. As shown, the secondary protuberance 38 is a rectangular prism having a plurality of rounded edges and a rounded transitionary surface formed between the secondary protuberance 38 and the first inner surface 34 of the mounting collar 14. However, other shapes such as a cylindrical prism, a bulbous protuberance, or any other shape may be used. The secondary protuberance 38 is formed adjacent the manifold aperture 40 on the first inner surface 34 of the mounting collar 14, a portion of the secondary protuberance 38 formed by an inner peripheral wall 46 defining the manifold aperture 40. Alternately, the secondary protuberance 38 may be formed elsewhere on the first inner surface 34. The secondary protuberance 38 is unitarily formed with the mounting collar 14, but may be formed separate the mounting collar 14 and coupled thereto using a fastener, a weld, or the like.

The manifold aperture 40 is formed through the first inner surface 34 and the second outer surface 36. The first inner surface 34 is substantially parallel to the second outer surface 36. The inner peripheral wall 46 defines the manifold aperture 40, the inner peripheral wall 46 being a stepped wall, as shown in FIG. 3. A first peripheral edge 48 located between the inner peripheral wall 46 and the first inner surface 34 has a substantially circular shape and a second peripheral edge 50 located between the inner peripheral wall 46 and the second outer surface 36 has a substantially circular shape. A diameter of the second peripheral edge 50 is greater than a diameter of the first peripheral edge 48.

As illustrated, the second peripheral edge 50 may include a chamfer formed therewith and an interior peripheral edge 52 formed by the stepped wall may include a fillet formed therewith. Any other combination of chamfers and fillets may be formed with the first peripheral edge 48, the second peripheral edge 50, and the interior peripheral edge 52 formed by the inner peripheral wall 46.

The fastening point 42 is a perforation formed through the mounting collar 14. The fastening point 42 is a circular aperture formed outboard from the inner peripheral wall 46 in each of the diametrically opposed rounded tabs. Alternately, the fastening point 42 may be a notch formed in a peripheral edge of the mounting collar 14, a slot formed through the mounting collar 14, each of the tabs extending from the mounting collar 14, or any other portion of the mounting collar 14. As shown in FIG. 2, a threaded fastener is disposed through the fastening point 42 and into a threaded aperture (not shown) formed in the cylinder head 44, the threaded fastener coupling the mounting collar 14 to the cylinder head 44.

The resilient annulet 16 is disposed between the engine manifold 12 and the mounting collar 14. As most clearly illustrated in FIG. 3, the resilient annulet 16 is an annulet having a stepped profile. The resilient annulet 16 is sealingly engaged with the resilient sleeve 22 and includes a first flange portion 54, a second flange portion 56, and a sealing ridge 58. The resilient annulet 16 is formed from an elastomeric material, however any other suitable material typically used to form seals or the like may be used.

The resilient annulet 16 is molded to the inner peripheral wall 46. The mounting collar 14 including the resilient annulet 16 molded to the inner peripheral wall 46 is formed by placing the mounting collar 14 within a set of molding dies (not shown) corresponding to a shape of the mounting collar 14 including the resilient annulet 16. A moldable material is injected into the set of molding dies, the moldable material adhering to the inner peripheral wall 46 to form the mounting collar 14 including the resilient annulet 16. Alternately, an adhesive disposed between the resilient annulet 16 and the inner peripheral wall 46 may couple the resilient annulet 16 thereto. Further, a frictional force between the resilient annulet 16 and the inner peripheral wall 46 may couple the resilient annulet 16 thereto.

The first flange portion 54 is a portion of the resilient annulet 16 abuttingly disposed on at least a portion of the inner peripheral wall 46 of the mounting collar 14. A cross-sectional shape of the first flange portion 54 is substantially rectangular. A first distal end of the first flange portion 54 extends to the first peripheral edge 48. A second distal end of the first flange portion 54 is formed with the sealing ridge 58 and a central rectangular portion 60 of the resilient annulet 16.

The second flange portion 56 is a portion of the resilient annulet 16 abuttingly disposed on at least a portion of the inner peripheral wall 46 of the mounting collar 14 and extending from the central rectangular portion 60 beyond the second outer surface 36. A cross-sectional shape of the second flange portion 56 is substantially rectangular and is substantially parallel to the first flange portion 54. A portion of the second flange portion 56 extending beyond the second outer surface 36 forms an interfacial seal between the mounting collar 14 and the cylinder head 44.

The sealing ridge 58 is a portion of the resilient annulet 16 having a substantially triangular cross-section. The sealing ridge 58 is formed between the first flange portion 54 and the second flange portion 56 and extends inboard from the central rectangular portion 60 and the first flange portion 54 of the resilient annulet 16. A shape of the sealing ridge 58 substantially corresponds to the sealing groove 32, forming a seal between the resilient sleeve 22 and the resilient annulet 16 when the engine manifold 12 is disposed in the mounting collar 14. Alternately, the resilient annulet 16 may include a groove formed therewith for receiving a portion of the resilient sleeve 22.

In use, the manifold assembly 10 for the engine minimizes a number of components of the manifold assembly 10 and minimizes a time of assembly of the manifold assembly 10. The resilient annulet 16 disposed between the mounting collar 14 and the engine manifold 12 simplifies a proper alignment of the mounting collar 14 and the engine manifold 12 when coupling the manifold assembly 10 to the cylinder head 44. Further, the manifold assembly 10 militates against a rotation of the engine manifold 12. As shown in FIGS. 2-3, the primary protuberance 24 abuts the secondary protuberance 38. When the engine manifold 12 or any attachment thereto is subjected to a force that would result in the rotation of the engine manifold 12 with respect to the mounting collar 14, abutment of the primary protuberance 24 and the secondary protuberance 38 militates against a rotation of the engine manifold 12. Accordingly, damage to the resilient sleeve 22 and the resilient annulet 16 that may result due to movement between the engine manifold 12 and the mounting collar 14 is also minimized.

In accordance with the provisions of the patent statutes, the present invention has been described in what is considered to represent its preferred embodiments. However, it should be noted that the invention can be practiced otherwise than as specifically illustrated and described without departing from its spirit or scope.

What is claimed is:

1. A manifold assembly for an engine, comprising:
an engine manifold having an inlet, at least one outlet, a resilient sleeve coupled to at least a portion of an outer surface of said engine manifold adjacent the at least one outlet of said engine manifold, and a primary protuberance formed adjacent the at least one outlet on the outer surface of said engine manifold;
a mounting collar disposed adjacent the at least one outlet of said engine manifold having a secondary protuberance and an inner peripheral wall defining a manifold aperture, the manifold aperture formed through said mounting collar; and
a resilient annulet coupled to the inner peripheral wall, wherein said resilient annulet is sealingly engaged with the resilient sleeve, and the primary protuberance abuts the secondary protuberance to militate against a rotation of said engine manifold with respect to said mounting collar.

2. The manifold assembly for an engine of claim 1, wherein said mounting collar includes a first inner surface and a second outer surface, the first inner surface substantially parallel to the second outer surface.

3. The manifold assembly for an engine of claim 2, wherein the primary protuberance is unitarily formed with said engine manifold and the secondary protuberance is unitarily formed with said mounting collar, the secondary protuberance formed on the first inner surface.

4. The manifold assembly for an engine of claim 2, wherein a first peripheral edge located between the inner peripheral wall and the first inner surface has a substantially circular shape and a first peripheral edge diameter, and a second peripheral edge located between the inner peripheral wall and the second outer surface has a substantially circular shape and a second peripheral edge diameter, the second peripheral edge diameter greater than the first peripheral edge diameter.

5. The manifold assembly for an engine of claim 2, wherein the primary protuberance and the secondary protuberance are rounded bodies respectively extending from the outer surface of said engine manifold and the first inner surface of said mounting collar.

6. The manifold assembly for an engine of claim 1, wherein said resilient annulet includes a first flange portion, a second flange portion, and a sealing ridge formed therewith, the sealing ridge formed between the first flange portion and the second flange portion, the second flange portion substantially parallel to the first flange portion.

7. The manifold assembly for an engine of claim 6, wherein the second flange portion extends beyond an outer surface of said mounting collar.

8. The manifold assembly for an engine of claim 1, wherein a cross-sectional shape of said engine manifold is substantially ring shaped and a portion of said engine manifold has a diameter less than a remaining portion of said engine manifold.

9. The manifold assembly for an engine of claim 1, wherein a portion of the secondary protuberance is formed by the inner peripheral wall.

10. The manifold assembly for an engine of claim 1, wherein a portion of said resilient annulet forms an interfacial seal between said mounting collar and an cylinder head.

11. The manifold assembly for an engine of claim 1, wherein the resilient sleeve includes a sealing groove formed therein.

12. The manifold assembly for an engine of claim 1, wherein said engine manifold includes a stepped portion formed in the outer surface thereof adjacent the at least one outlet of said engine manifold.

13. The manifold assembly for an engine of claim 1, wherein said mounting collar includes two fastening points formed therein, the two fastening points formed outboard from the inner peripheral wall.

14. The manifold assembly for an engine of claim 1, wherein the inner peripheral wall is a stepped wall.

15. A manifold assembly for an engine, comprising:
an engine manifold having an inlet, at least one outlet, a resilient sleeve molded to a stepped portion of an outer surface of said engine manifold adjacent the at least one outlet of said engine manifold, and a primary protuberance formed adjacent the at least one outlet on the outer surface of said engine manifold;
a mounting collar disposed adjacent the at least one outlet of said engine manifold having a first inner surface, a second outer surface, a secondary protuberance, and an inner stepped wall, the secondary protuberance disposed on the first inner surface and the inner stepped wall defining a manifold aperture, the manifold aperture formed through said mounting collar; and
a resilient annulet coupled to the inner stepped wall, wherein said resilient annulet is sealingly engaged with the resilient sleeve, and the primary protuberance abuts the secondary protuberance to militate against a rotation of said engine manifold with respect to said mounting collar.

16. The manifold assembly for an engine of claim 15, wherein a first peripheral edge located between the inner stepped wall and the first inner surface has a substantially circular shape and a first peripheral edge diameter and a second peripheral edge located between the inner stepped wall and the second outer surface has a substantially circular shape and a second peripheral edge diameter, the second peripheral edge diameter greater than the first peripheral edge diameter.

17. The manifold assembly for an engine of claim 15, wherein said resilient annulet includes a first flange portion, a second flange portion, and a sealing ridge formed therewith, the sealing ridge formed between the first flange portion and the second flange portion, the second flange portion substantially parallel to the first flange portion.

18. The manifold assembly for an engine of claim 15, wherein the primary protuberance and the secondary protuberance are rounded bodies respectively extending from the outer surface adjacent the primary protuberance and the first inner surface adjacent the secondary protuberance.

19. The manifold assembly for an engine of claim 15, wherein the second flange portion extends beyond an outer surface of said mounting collar to form an interfacial seal between said mounting collar and a cylinder head.

20. A manifold assembly for an engine, comprising:
an engine manifold comprising:
an inlet;
at least one outlet;
a stepped portion formed on an outer surface of said engine manifold adjacent said at least one outlet;
a resilient sleeve having a sealing groove formed therein molded to said stepped portion; and
a primary protuberance disposed on the outer surface of said engine manifold, wherein said primary protuberance is disposed adjacent said at least one outlet of said engine manifold;
a mounting collar disposed on said resilient sleeve, comprising:
a first inner surface;
a second outer surface substantially parallel to said first inner surface;
a secondary protuberance disposed on said first inner surface; and
an inner stepped wall defining a manifold aperture formed through said mounting collar, wherein a first peripheral edge located between said inner stepped wall and said first inner surface has a substantially circular shape and a first peripheral edge diameter and a second peripheral edge located between said inner stepped wall and the second outer surface has a substantially circular shape and a second peripheral edge diameter, the second peripheral edge diameter greater than the first peripheral edge diameter; and
a resilient annulet molded to said inner stepped wall comprising:
a first flange portion sealingly engaged with said inner stepped wall;
a second flange portion forming an interfacial seal between said mounting collar and a cylinder head coupled thereto; and
a sealing ridge sealingly engaged with the sealing groove of the resilient sleeve, wherein the primary protuberance abuts the secondary protuberance to militate against a rotation of said engine manifold with respect to said mounting collar.
